(19) United States
(12) Patent Application Publication
(10) Pub. No.: US 2026/0062558 A1
(43) Pub. Date: Mar. 5, 2026

(54) COATINGS COMPRISING SILICATE

(71) Applicant: SWIMC LLC, Cleveland, OH (US)

(72) Inventor: Bryan G. Newman, Columbus, OH (US)

(21) Appl. No.: 19/311,252

(22) Filed: Aug. 27, 2025

Related U.S. Application Data
(60) Provisional application No. 63/687,340, filed on Aug. 27, 2024.

(51) Int. Cl. C09D 5/00; C08K 3/34; C08K 9/04; C09D 7/41; C09D 7/62; C09D 7/80; C09D 133/12; C09D 175/04

(52) U.S. Cl. CPC C09D 5/002; C08K 3/34; C08K 9/04; C09D 7/41; C09D 7/62; C09D 7/80; C09D 133/12; C09D 175/04

(57) ABSTRACT

The present application relates to a primer coating composition comprising at least one resin and at least one silicate. At least one resin comprises at least one acrylic latex, at least one polyurethane dispersion, at least one epoxy resin, an alkali-soluble resin, or combinations thereof. Further, at least one silicate comprises sodium silicate, potassium silicate, magnesium silicate, calcium silicate, lithium silicate, ammonium silicate, orthosilicates, or combinations thereof. The silicate may be added during processing or post-added to the primer coating composition. A method of preparing the primer coating composition described herein and an article comprising the primer coating composition described herein are also provided.

### FIELD

The present disclosure relates generally to a primer coating composition comprising at least one resin and at least one silicate. At least one resin comprises at least one acrylic latex, at least one polyurethane dispersion, at least one epoxy resin, an alkali-soluble resin, or combinations thereof. Further, at least one silicate comprises sodium silicate, potassium silicate, magnesium silicate, calcium silicate, lithium silicate, ammonium silicate, orthosilicates, or combinations thereof. The silicate may be added during processing or post-added to the primer coating composition. A method of preparing the primer coating composition described herein and an article containing the primer coating composition described herein are also provided.

### BACKGROUND

Exterior coatings must provide both durability and beautification to outdoor applications. Formulating these products is difficult due to the extreme temperature, humidity, and precipitation variations throughout world. In order to protect surfaces against prolonged exposure to the elements, including temperature and humidity extremes, these coatings must be able to withstand strenuous environments and be easy to apply.

In addition, exterior coatings must be able to adhere to a variety of substrates, including but not limited to various species of wood, metal, plastic, composites (including fiber cement board), concrete, cement, ceramics, and combinations of these materials. Certain properties may improve with changes to coatings formulations while others may suffer due to these modifications. In particular, properties such as adhesion, UV protection, weatherability (especially with extreme temperatures and humidities), and lower VOC are difficult to achieve.

Further, consumers are frequently demanding that these coatings must adhere to a plurality of substrates typically found on a home or other structure. This is especially difficult in environments in which adhesion and weatherability are difficult to achieve.

Both water glass (sodium silicate in the form of lumps, powders, or liquids made from sodium oxide and silica) and water-soluble silicate salts (made into solution for use as a sealer) treatments have been known in the masonry industries and has been used for decades. These types of products penetrate into cementitious substrates to provide a substantially impenetrable water barrier in these porous substrates that help prevent water absorption and providing high durability. However, both water glass and silicate salts treatment options provide a clear treatment, and subsequent layers of pigmented coatings must adhere to either the water glass or silicate salts treatment as well as any portions of the substrate that may not have this treatment. Ultimately, multiple coats of either the water glass or water-soluble silicate salts would need to be applied prior to any coating, resulting in additional time, cost, and labor. Further, the coating would need to be formulated to properly adhere to the water glass or water-soluble silicate salts. Typical coatings comprising epoxy, polyurethanes, and/or acrylics are still permeable to such water by themselves, so they do not provide any long-term substantial protection as a water barrier.

Manufacturers and consumers, especially automotive, aerospace, marine, general industrial, wood, plastics, electronics, and other consumer goods manufacturers, have increasingly demanded for these particular performance requirements for coatings. Manufacturers and consumers are continually looking for coatings that exhibit these improved properties, such as improved weatherability, freeze-thaw resistance, wear resistance, and adhesion over a variety of substrates without sacrificing other performance properties. Manufacturers and consumers also desire a coating that can provide a barrier for certain substrates to reduce or eliminate any water intrusion. In view of these challenges with many conventional coatings, the need therefore remains for improved coatings having a binder and other additives that can provide weatherability, wear resistance, adhesion, weather resistance, gloss retention, lower VOC's, and other improved properties as well as other advantages.

### SUMMARY

The embodiments of what is described herein are not intended to be exhaustive or to limit what is provided in the claimed subject matter and disclosed in the detailed description. Rather, the embodiments are chosen and described so that others skilled in the art may appreciate and understand the principles and practices of what is provided in the claimed subject matter.

A coating and methods of preparing are shown and described. What is disclosed relates a primer coating composition comprising at least one resin and at least one silicate. At least one resin comprises at least one acrylic latex, at least one polyurethane dispersion, at least one epoxy resin, an alkali-soluble resin, or combinations thereof. Further, at least one silicate comprises sodium silicate, potassium silicate, magnesium silicate, calcium silicate, lithium silicate, ammonium silicate, orthosilicates, or combinations thereof. The silicate may be added during processing or post-added to the primer coating composition. A method of preparing the primer coating composition described herein and an article containing the primer coating composition described herein are also provided.

A method of making the primer coating composition comprising at least one resin and at least one silicate is disclosed herein. An article containing the primer coating composition comprising at least one resin and at least one silicate is also described.

To the accomplishment of the foregoing and related ends, the following description set forth certain illustrative aspects and implementations. These are indicative of a few of the various ways in which one or more aspects may be employed. Other aspects, advantages and novel features of the disclosure will become apparent from the following detailed description when considered.

### DETAILED DESCRIPTION

Aspects of what is described herein are disclosed in the following description related to specific embodiments. Alternative embodiments may be devised without departing from the scope of what is described herein. Additionally, well-known embodiments of what is described herein may not be described in detail or will be omitted so as to not obscure the relevant details of what is described herein. Further, to facilitate an understanding of the description, discussion of several terms used herein follows.

As used herein, the word “exemplary” means “serving as an example, instance, or illustration.” The embodiments described herein are not limiting, but rather exemplary only. It should be understood that the described embodiments are not necessarily to be construed as preferred or advantageous over other embodiments. Moreover, the term “embodiment(s)” does not require that all embodiments include the discussed feature, advantage, or mode of operation.

The present disclosure relates generally to coatings that provide advantageous improvements over current coatings. It has been discovered that the use of a particular coating comprising at least one resin and at least one silicate can surprisingly lead to improved performance properties when used in a coating, namely weatherability, wear resistance, freeze-thaw resistance, adhesion, weather resistance, gloss retention, lower VOC's as well as other advantages.

In many embodiments, a primer coating composition at least partially applied directly to a substrate may comprise at least one resin and at least one silicate. Not to be bound by theory, the primer coating composition described herein comprising at least one resin and at least one silicate may provide mechanisms similar to using traditional water glass, ultimately providing properties like substantially impenetrable water barrier in these porous substrates that help prevent water absorption and providing high durability. However, the primer coating composition described herein comprises at least one resin along with at least one silicate, so a coating may be formed on the substrate that may help to form a substantial barrier on a substrate to reduce water intrusion and therefore improve certain properties such as freeze-thaw resistance, adhesion, and other characteristics of the coating.

In many embodiments, the primer coating composition described herein may be an exterior coating. In some embodiments, the primer coating composition may be an interior coating. In one embodiment, the primer coating composition described herein may be both an exterior coating and an interior coating. In some embodiments, the primer coating composition described herein is a 1 K (one-part) coating. In other embodiments, the primer coating composition is a 2 K (two-part) coating. In yet other embodiments, the primer coating composition has more than two-parts, such as a 3 K system. In another embodiment, the primer coating composition may be used as a top coat.

In many embodiments, at least one resin of the primer coating composition described herein comprises at least one acrylic latex, at least one polyurethane dispersion, at least one epoxy resin, an alkali-soluble resin, or combinations thereof. In another embodiment, at least one resin is an acrylic polyol. Other resins are also contemplated. In some embodiments, at least one resin comprises 15% to 50% by weight of the primer coating composition formula. In other embodiments, at least one resin can, for example, range from 15% to 45%, from 15% to 40%, from 15% to 35%, from 15% to 30%, from 15% to 25%, from 20% to 50%, from 20% to 45%, from 20% to 40%, from 20% to 35%, from 20% to 30%, from 25% to 50%, from 25% to 45%, from 25% to 40%, from 25% to 35%, from 30% to 50%, from 30% to 45%, from 30% to 40%, from 35% to 50%, from 35% to 45%, and from 40% to 50%, by weight of the primer coating composition formula. Larger and smaller ranges for at least one resin are also contemplated.

In many embodiments, at least one resin is an acrylic latex. In some embodiments, at least one acrylic latex comprises methyl methacrylate, methyl acrylate, ethyl methacrylate, isopropyl acrylate, isopropyl methacrylate, n-propyl acrylate, n-propyl methacrylate, n-butyl acrylate, n-butyl methacrylate, isobutyl acrylate, isobutyl methacrylate, t-butyl acrylate, t-butyl methacrylate, n-pentyl acrylate, n-pentyl methacrylate, isopentyl acrylate, isopentyl methacrylate, neopentyl acrylate, neopentyl methacrylate, n-hexyl acrylate, n-hexyl methacrylate, isohexyl acrylate, isohexyl methacrylate, neohexyl acrylate, neohexyl methacrylate, cyclobutyl acrylate, cyclobutyl methacrylate, cyclopentyl acrylate, cyclopentyl methacrylate, cyclohexyl acrylate, and cyclohexyl methacrylate. Other monomers for the acrylic latex are also contemplated.

In many embodiments, the Tg of at least one acrylic latex ranges from 0° C. to 50° C. as measured by Differential Scanning calorimetry (DSC) using ASTM D6604-00. In many other embodiments, at least one acrylic latex can, for example, range from a Tg of 0° C. to 45° C., from a Tg of 0° C. to 40° C., from a Tg of 0° C. to 35° C., from a Tg of 0° C. to 30° C., from a Tg of 0° C. to 25° C., from a Tg of 0° C. to 20° C., from a Tg of 0° C. to 15° C., from a Tg of 0° C. to 10° C., from a Tg of 5° C. to 50° C., from a Tg of 5° C. to 45° C., from a Tg of 5° C. to 40° C., from a Tg of 5° C. to 35° C., from a Tg of 5° C. to 30° C., from a Tg of 5° C. to 25° C., from a Tg of 5° C. to 20° C., from a Tg of 5° C. to 15° C., from a Tg of 5° C. to 10° C., from a Tg of 10° C. to 50° C., from a Tg of 10° C. to 45° C., from a Tg of 10° C. to 40° C., from a Tg of 10° C. to 35° C., from a Tg of 10° C. to 30° C., from a Tg of 10° C. to 25° C., from a Tg of 10° C. to 20° C., from a Tg of 15° C. to 50° C., from a Tg of 15° C. to 45° C., from a Tg of 15° C. to 40° C., from a Tg of 15° C. to 35° C., from a Tg of 15° C. to 30° C., from a Tg of 15° C. to 25° C., from a Tg of 20° C. to 50° C., from a Tg of 20° C. to 45° C., from a Tg of 20° C. to 40° C., from a Tg of 20° C. to 35° C., from a Tg of 20° C. to 30° C., from a Tg of 25° C. to 50° C., from a Tg of 25° C. to 45° C., from a Tg of 25° C. to 40° C., from a Tg of 25° C. to 35° C., from a Tg of 30° C. to 50° C., from a Tg of 30° C. to 45° C., from a Tg of 30° C. to 40° C., from a Tg of 35° C. to 50° C., from a Tg of 35° C. to 45° C., and from a Tg of 40° C. to 50° C. Other Tg ranges are also contemplated.

In some embodiments, at least one polyurethane dispersion is formed from at least one isocyanate having an NCO/OH ratio (isocyanate index) of 1:1 to 5:1, The primer coating composition described herein may have at least one polyurethane dispersion formed from at least one isocyanate having an NCO/OH ratio (isocyanate index) ranging from 1:1 to 4.5:1, from 1:1 to 4:1, from 1:1 to 3.5:1, from 1:1 to 3:1, from 1:1 to 2.5:1, from 1:1 to 2:1, and from 1:1 to 1.5:1. wherein the OH represents the total moles of the hydroxyl groups in the resin systems. The ratio can, for example, be about 1:1 to about 4:1, about 1:1 to about 3:1, and about 1:1 to about 2:1. Other ratios are also contemplated.

In many embodiments, at least one silicate comprises sodium silicate, potassium silicate, magnesium silicate, calcium silicate, lithium silicate, ammonium silicate, orthosilicates, or combinations thereof. In some embodiments, at least one silicate comprises 1% to 6% by weight of the primer coating composition formula. In other embodiments, at least one silicate can, for example, range by weight from 1% to 5%, from 1% to 4%, from 1% to 3%, from 1% to 2%, from 2% to 6%, from 2% to 5%, from 3% to 6%, from 3% to 5%, from 3% to 5%, and from 4% to 5 In yet other embodiments, at least one silicate can, for example, be less than 6% of the primer coating composition. In other embodiments, at least one silicate can, for example, be less than 5.5% of the primer coating composition, less than 5% of the primer coating composition, less than 4.5% of the primer coating composition, less than 4% of the primer coating composition, less than 3.5% of the primer coating composition, less than 3% of the primer coating composition, less than 2.5% of the primer coating composition, less than 2% of the primer coating composition, less than 1.5% of the primer coating composition, and less than 1% of the primer coating composition. Other ranges are also contemplated.

In some embodiment, at least one silicate is a modified silicate. In one embodiment, the modified silicate is a surface modification. In one embodiment, the surface modification may incorporate different function groups, resulting in a more hydrophobic or hydrophilic surface. In one embodiment, the modified silicate is substantially water soluble. In one embodiment, the modified silicate is at least partially water soluble. In one embodiment, the modified silicate is organically modified ammonium silicates. In one embodiment, the modified silicate is magnesium aluminosilicate. In yet another embodiment, the modified silicate is organically modified magnesium silicate.

In one embodiment, at least one silicate is a solid. In another embodiment, at least one silicate is a liquid.

For the primer coating composition described herein, the silicate may be incorporated into the primer coating composition in several different ways. In one embodiment, at least one silicate is added to the primer coating composition during processing. The silicate may be added during the grind, pre-thin, thindown, or combinations thereof. In another embodiment, at least one silicate is post-added to the primer coating composition.

Further, in many embodiments, the primer coating composition contains less than 5% pigments. In yet another embodiment, the primer coating composition contains less than 4.5% pigments. In still another embodiment, the primer coating composition contains less than 4% pigments. In another embodiment, the primer coating composition contains less than 3.5% pigments. In other embodiments, the primer coating composition contains less than 3% pigments or less than 2.5% pigments. In one embodiment, the primer coating composition contains less than 2% pigments. In another embodiment, the primer coating composition contains less than 1.5% pigments. In one embodiment, the primer coating composition contains less than 1% pigments. These pigments may be typical pigments used in coating compositions, including but not limited to titanium dioxide, mica, calcium carbonate, kaolin, silica, and combinations thereof.

In many embodiments, the primer coating composition described herein comprises: 15%-50% by weight at least one acrylic latex; 15%- 50% by weight at least one polyurethane dispersion; and 1%- 20% by weight at least one silicate. The primer coating composition described herein and comprising 15%- 50% by weight at least one acrylic latex; 15%- 50% by weight at least one polyurethane dispersion; and 1%- 20% by weight at least one silicate may also comprise other components as described below. The other components may comprise 1% to 69% by weight of the primer coating composition.

In another embodiment, the primer coating composition described herein comprises: 15%-99% by weight at least one acrylic latex and 1%- 20% by weight at least one silicate. The primer coating composition described herein and comprising 15%- 99% by weight at least one acrylic latex and 1%- 20% by weight at least one silicate may also comprise other components as described below. The other components may comprise 1% to 84% by weight of the primer coating composition.

In yet another embodiment, the primer coating composition described herein comprises: 80%- 99% by weight at least one polyurethane dispersion and 1%- 20% by weight at least one silicate. The primer coating composition described herein and comprising 15%- 99% by weight at least one polyurethane dispersion and 1%- 20% by weight at least one silicate may also comprise other components as described below. The other components may comprise 1% to 84% by weight of the primer coating composition.

Additionally, the primer coating composition described herein may comprise other components. The primer coating composition described herein may further comprise at least one binder, thickener, defoamer, surfactant, dispersant, matting agent, solvent, antimicrobial agent, pigment, hardener, pH adjuster, or combinations thereof. These further components may also include, but are not limited to, other polymers or polymer dispersions, surfactants, dispersants, defoamers, biocides, mildewcides, algaecides, thickeners, leveling agents, anti-settling agents, pH buffers, corrosion inhibitors, driers, anti-skinning agents, anti-cratering agents, anti-sag agents, heat stabilizers, UV absorbers/inhibitors, antioxidants, wetting agents, flatteners and other inert pigments (such as titanium dioxide, dyes, clay, amorphous and surface treated silica, calcium carbonate, and the like, and combinations thereof), flow agents, and the like, and various combinations thereof as needed for a particular application.

Further, the primer coating composition described herein contains substantially no acrylamides. The term “substantially no acrylamide” may be less than 1% by weight, less than 0.9% by weight, less than 0.75% by weight, less than 0.5% by weight, less than 0.4% by weight, less than 0.3% by weight, less than 0.2% by weight, less than 0.1% by weight, less than 0.05% by weight, and less than 0.01% by weight.

For the primer coating composition described herein, the primer coating composition is substantially clear. Further, the primer coating composition is substantially transparent.

Additionally, the primer coating composition may further comprise at least one topcoat at least partially coated onto the primer coating composition. The primer coating composition may also further comprise at least one additional primer coating composition described herein.

In some embodiments, the primer coating composition described herein has a viscosity change of no more than 10 units according to ASTM D562 after 5 cycles of freeze thaw resistance testing according to ASTM D2243.

In many embodiments, the primer coating composition described herein has a thickness difference of no more than 10% according to ASTM D6132 after 50 cycles of repeated thermal cycle testing according to ASTM D6944-15. Using ASTM D6944-15 measures any changes in the coating's thickness after repeated cold and moisture exposure and may demonstrate a coating's resistance to repeated cycles and its protection of the substrate. Specifically, this testing evaluates any swelling of the coating that may occur after repeated cold and moisture exposure. In other embodiments, the coating described herein can after 50 cycles, for example, be no more than 9%, no more than 8%, no more than 7%, no more than 6%, no more than 5%, no more than 4%, no more than 3%, and no more than 2%. In many other embodiments, the primer coating composition described herein has a thickness difference of no more than 10% according to ASTM D6132 after 75 cycles of repeated thermal cycle testing according to ASTM D6944-15. In other embodiments, the primer coating composition described herein can after 75 cycles, for example, be no more than 9%, no more than 8%, no more than 7%, no more than 6%, no more than 5%, no more than 4%, and no more than 3%. In yet another embodiment, the primer coating composition described herein has a thickness difference of no more than 10% according to ASTM D6132 after 90 cycles of repeated thermal cycle testing according to ASTM D6944-15. In other embodiments, the primer coating composition described herein can after 90 cycles, for example, be no more than 9%, no more than 8%, no more than 7%, no more than 6%, no more than 5%, and no more than 4%. In still yet another embodiment, the primer coating composition described herein has a thickness difference of no more than 10% according to ASTM D6132 after 100 cycles of repeated thermal cycle testing according to ASTM D6944-15. In other embodiments, the primer coating composition described herein can after 100 cycles, for example, be no more than 9%, no more than 8%, no more than 7%, no more than 6%, no more than 5%, and no more than 4%. Lower ranges may be contemplated.

In many embodiments, the primer coating composition is a paint, stain, varnish, clearcoat, lacquer, drying oil, or powder. In many embodiments, the primer coating composition is a primer, intermediate coat, or topcoat. In particular, the primer coating composition described herein is a primer at least partially applied over at least one substrate. The substrate may be wood (including both natural and engineered wood), metal, cement, concrete, masonry, and other cementitious substrates (like cement board or fiber cement board), paper, ceramic, plastic, composites, or combinations thereof. Natural wood may include but is not limited to oak (e.g., white oak and red oak), pine (e.g., white pine and southern ponderosa pine), aspen, spruce, cherry, walnut, redwood, cedar, maple, mahogany, birch, hickory, walnut, ash, rosewood, or derivatives thereof (such as veneer). Engineered wood may include but is not limited to plywood oriented strand board (OSB), medium density fiberboard (MDF), particle board, and composite shiplap. The primer coating composition described herein is also particularly suitable in the preparation of building materials substrates, including but not limited to metal, plastics, wood (including both natural and engineered wood), ceramics, cement, concrete, masonry, and other cementitious substrates (like cement board or fiber cement board), composites, or combinations thereof. In particular, the primer coating composition described herein may improve the resistance to water swelling in the coating, particularly in substrates that are not moisture proof like OSB and MDF. The primer coating composition described herein may show particular utility as clear coats, base coats, pigmented topcoats, primers, and other coatings, especially in the building materials coatings market. In one embodiment, the primer coating composition is at least partially coated onto a base coat or primer. In another embodiment, at least one additional primer coating composition may be applied to the primer coating composition described herein, and the additional coating may be the coating described herein or a different coating.

Further disclosed is a method of preparing the primer coating composition described herein. The primer coating composition described herein and comprising at least one resin and at least one silicate. At least one resin comprises at least one acrylic latex, at least one polyurethane dispersion, at least one epoxy resin, an alkali-soluble resin, or combinations thereof. Further, at least one silicate comprises sodium silicate, potassium silicate, magnesium silicate, calcium silicate, lithium silicate, ammonium silicate, orthosilicates, or combinations thereof.

Also disclosed is an article comprising the primer coating composition described herein. In one embodiment, an article may comprise: 1) a substrate having at least one surface; and 2) the primer coating composition described herein and comprising at least one resin and at least one silicate. At least one resin comprises at least one acrylic latex, at least one polyurethane dispersion, at least one epoxy resin, an alkali-soluble resin, or combinations thereof. Further, at least one silicate comprises sodium silicate, potassium silicate, magnesium silicate, calcium silicate, lithium silicate, ammonium silicate, orthosilicates, or combinations thereof. In many embodiments, the substrate comprises wood, metal, glass, plastic, paper, leather, fabric, ceramic, or any combination thereof. Other substrates are also contemplated. In some embodiments, the primer coating composition described herein may be applied to a substrate by way of roll coating, spray coating, curtain coating, dip coating, brush coating, pad coating, or some other suitable coating process. Other application methods are also contemplated. In some embodiments, at least a portion of the substrate may be coated with the primer coating composition. Curing temperatures preferably are between 0 and 80° C. and more preferably between 10 and 60° C. Humidity conditions may range from 5% relative humidity to 95% relative humidity.

### Test Results

The primer coating composition described herein (in Tables 1a and 1b below prepared as Sample A and Sample B) was tested against two exterior paint controls (in Tables 1 and 2 and prepared as Control A and Control B) having a dry film thickness (DFT) as measured by cross section microscopy of 0.25 mils to 1 mil (0.006 mm to 0.0254 mm). Control A, Control B, Sample A, and Sample B are all waterborne coatings that were applied to a composite substrate. All coatings contain at least one acrylic latex, although some may be blended with other resins. Neither Control A nor Control B contain any silicates. Sample A and Sample B both contain at least one silicate according to what is claimed in this application. Samples A and B and Controls A and B were tested according to ASTM D6944-15 for film thickness as measured by ASTM D6132, but additional cycles (as noted) were done to further challenge the samples and controls. Samples are considered as passing the test when the results are less than 105% and keep close to the original thickness, and anything equal or greater than 105% considered as failing the test.

TABLE 1a
Performance Testing Results to Day 90

| | | # of Cycles [symbol] | | | | | | | | |
|---|---|---|---|---|---|---|---|---|---|---|
| | | 0 | 10 | 20 | 35 | 45 | 55 | 70 | 80 | 90 |
| Control A | Base (water) | 100.00% | 101.94% | 102.89% | 104.55% | 105.46% | 106.16% | 107.63% | 109.28% | 110.50% |
| | Top (air) | 100.00% | 100.99% | 102.13% | 103.50% | 104.57% | 105.76% | 107.45% | 107.65% | 106.64% |
| Control B | Base (water) | 100.00% | 99.94% | 100.21% | 100.91% | 101.47% | 101.74% | 103.11% | 103.64% | 104.40% |
| | Top (air) | 100.00% | 99.98% | 99.78% | 100.14% | 100.13% | 100.65% | 100.95% | 101.11% | 101.37% |
| Sample A | Base (water) | 100.00% | 100.14% | 101.04% | 102.93% | 103.25% | 104.65% | 106.03% | 107.46% | 109.70% |
| | Top (air) | 100.00% | 100.05% | 100.52% | 102.54% | 103.70% | 105.13% | 105.68% | 108.71% | 108.32% |
| Sample B | Base (water) | 100.00% | 99.73% | 100.09% | 101.32% | 101.52% | 102.60% | 103.04% | 104.59% | 104.99% |
| | Top (air) | 100.00% | 99.81% | 100.08% | 100.86% | 101.66% | 101.87% | 102.48% | 102.68% | 103.32% |

TABLE 1b
Performance Testing Results for Days 105 to 195

| | | # of Cycles [symbol] | | | | | | | | |
|---|---|---|---|---|---|---|---|---|---|---|
| | | 105 | 115 | 125 | 140 | 150 | 160 | 175 | 185 | 195 |
| Control A | Base (water) | 110.99% | 111.94% | 114.90% | 114.49% | 115.37% | 116.47% | 119.32% | — | — |
| | Top (air) | 108.45% | 109.14% | 108.54% | 110.53% | 111.39% | 112.43% | 112.46% | — | — |
| Control B | Base (water) | 106.06% | 107.44% | 109.40% | 110.87% | 112.56% | 114.06% | 118.35% | 119.15% | 121.69% |
| | Top (air) | 101.92% | 102.13% | 102.37% | 102.71% | 102.89% | 103.24% | 103.76% | 103.96% | 104.25% |
| Sample A | Base (water) | 110.71% | 112.69% | 114.38% | 115.98% | 116.00% | 119.12% | 121.97% | — | — |
| | Top (air) | 108.92% | 109.17% | 109.29% | 112.24% | 113.01% | 110.25% | 110.73% | — | — |
| Sample B | Base (water) | 105.63% | 106.54% | 107.02% | 108.19% | 108.63% | 109.50% | 111.63% | — | — |
| | Top (air) | 103.82% | 103.79% | 104.63% | 107.21% | 106.70% | 108.56% | 108.36% | — | — |

For Tables 2a and 2b below, the testing was repeated as described above for Sample B, and Sample C is yet another coating containing silicate as claimed in this application. Results are as follows.

TABLE 2a
Performance Testing Results to Day 130

| | | # of Cycles [symbol] | | | | | |
|---|---|---|---|---|---|---|---|
| | | 0 | 10 | 25 | 35 | 45 | 60 |
| Control A | Base (water) | 100.00% | 100.84% | 102.91% | 104.40% | 105.88% | 109.09% |
| | Top (air) | 100.00% | 100.97% | 103.95% | 105.10% | 107.21% | 107.82% |
| Control B | Base (water) | 100.00% | 99.87% | 99.85% | 99.86% | 100.36% | 100.21% |
| | Top (air) | 100.00% | 99.84% | 99.67% | 99.81% | 100.46% | 100.07% |
| Sample B | Base (water) | 100.00% | 100.17% | 100.69% | 101.21% | 102.40% | 102.19% |
| | Top (air) | 100.00% | 99.90% | 100.18% | 100.58% | 101.55% | 101.33% |
| Sample C | Base (water) | 100.00% | 99.82% | 99.95% | 100.00% | 100.19% | 100.81% |
| | Top (air) | 100.00% | 99.93% | 99.88% | 100.04% | 100.13% | 100.15% |
| | | # of Cycles [symbol] | | | | | |
| | | 70 | 80 | 95 | 105 | 115 | 130 |
| Control A | Base (water) | 108.75% | 111.62% | 114.04% | 114.07% | 115.48% | — |
| | Top (air) | 108.99% | 107.54% | 108.22% | 109.86% | 111.29% | — |
| Control B | Base (water) | 100.43% | 100.56% | 101.63% | 101.72% | 102.41% | 103.67% |
| | Top (air) | 100.11% | 100.43% | 100.61% | 100.48% | 100.80% | 101.49% |
| Sample B | Base (water) | 102.95% | 103.96% | 103.86% | 104.19% | 104.51% | 105.34% |
| | Top (air) | 102.83% | 102.81% | 103.57% | 104.54% | 105.50% | 106.78% |
| Sample C | Base (water) | 100.75% | 100.77% | 100.89% | 100.79% | 101.07% | 101.66% |
| | Top (air) | 100.28% | 100.20% | 100.13% | 100.48% | 100.33% | 101.16% |

TABLE 2b
Performance Testing Results for Days

| | | # of Cycles [symbol] | | | | | | |
|---|---|---|---|---|---|---|---|---|
| | | 140 | 150 | 165 | 175 | 185 | 200 | 210 |
| Control A | Base (water) | — | — | — | — | — | — | — |
| | Top (air) | — | — | — | — | — | — | — |
| Control B | Base (water) | 105.28% | 107.06% | 108.68% | 111.64% | 112.64% | 114.61% | 116.57% |
| | Top (air) | 101.77% | 102.40% | 103.99% | 104.49% | 105.82% | 106.88% | 107.95% |
| Sample B | Base (water) | 107.14% | 108.97% | 112.18% | 0.00% | 0.00% | 0.00% | 0.00% |
| | Top (air) | 108.77% | 109.54% | 110.09% | 0.00% | 0.00% | 0.00% | 0.00% |
| Sample C | Base (water) | 101.48% | 101.90% | 102.54% | 103.38% | 103.83% | 104.71% | 105.59% |
| | Top (air) | 100.65% | 100.44% | 100.65% | 100.86% | 101.17% | 101.50% | 101.83% |
| | | # of Cycles [symbol] | | | | | | |
| | | 220 | 235 | 245 | 255 | 270 | 280 | 290 |
| Control A | Base (water) | — | — | — | — | — | — | — |
| | Top (air) | — | — | — | — | — | — | — |
| Control B | Base (water) | — | — | — | — | — | — | — |
| | Top (air) | — | — | — | — | — | — | — |
| Sample B | Base (water) | — | — | — | — | — | — | — |
| | Top (air) | — | — | — | — | — | — | — |
| Sample C | Base (water) | 106.25% | 108.22% | 109.63% | 110.76% | 112.77% | 114.30% | 115.44% |
| | Top (air) | 101.86% | 102.80% | 103.66% | 103.50% | 104.20% | 104.60% | 105.11% |

Ideally for the testing in Tables la, 1b, 2a and 2b, there is a thickness difference of no more than 5% according to ASTM D6132. Many samples start to differentiate from each other after 50-55 cycles. For the test samples provided above, Sample A, Sample B, and Sample C have improved resistance to an increase in film thickness over Control A. Additionally Sample B had similar results to Control B until about 100 cycles. Sample C had noticeably improved results over both Controls A and B.

### Embodiments

The following embodiments are contemplated. All combinations of features and embodiments are contemplated.

Embodiment 1: A primer coating composition comprising at least one resin and at least one silicate, wherein the silicate is less than 5% by weight of the primer coating composition; and the primer coating composition contains less than 5% pigments

Embodiment 2: An embodiment of Embodiment 1, wherein at least one resin comprises at least one acrylic latex, at least one polyurethane dispersion, at least one epoxy resin, an alkali-soluble resin, or combinations thereof.

Embodiment 3: An embodiment of Embodiment 2, wherein at least one acrylic latex comprises methyl methacrylate, methyl acrylate, ethyl methacrylate, isopropyl acrylate, isopropyl methacrylate, n-propyl acrylate, n-propyl methacrylate, n-butyl acrylate, n-butyl methacrylate, isobutyl acrylate, isobutyl methacrylate, t-butyl acrylate, t-butyl methacrylate, n-pentyl acrylate, n-pentyl methacrylate, isopentyl acrylate, isopentyl methacrylate, neopentyl acrylate, neopentyl methacrylate, n-hexyl acrylate, n-hexyl methacrylate, isohexyl acrylate, isohexyl methacrylate, neohexyl acrylate, neohexyl methacrylate, cyclobutyl acrylate, cyclobutyl methacrylate, cyclopentyl acrylate, cyclopentyl methacrylate, cyclohexyl acrylate, and cyclohexyl methacrylate.

Embodiment 4: An embodiment of any of Embodiments 2-3, wherein the Tg of at least one acrylic latex ranges from 0° C. to 50° C. as measured by Differential Scanning calorimetry (DSC) using ASTM D6604-00.

Embodiment 5: An embodiment of Embodiment 2, wherein at least one polyurethane dispersion is formed from at least one isocyanate having an NCO/OH ratio (isocyanate index) of 1:1 to 5:1.

Embodiment 6: An embodiment of any of Embodiments 1-5, wherein at least one silicate comprises sodium silicate, potassium silicate, magnesium silicate, calcium silicate, lithium silicate, ammonium silicate, orthosilicates, or combinations thereof.

Embodiment 7: An embodiment of any of Embodiments 1-6, wherein at least one silicate is a modified silicate.

Embodiment 8: An embodiment of any of Embodiments 1-7, wherein at least one silicate is a solid.

Embodiment 9: An embodiment of any of Embodiments 1-7, wherein at least one silicate is a liquid.

Embodiment 10: An embodiment of any of Embodiments 1-9, wherein at least one silicate is added to the primer coating composition during processing.

Embodiment 11: An embodiment of any of Embodiments 1-9, wherein at least one silicate is post-added to the primer coating composition.

Embodiment 12: An embodiment of any of Embodiments 1-11, wherein at least one silicate comprises 2% to 5% by weight of the primer coating composition.

Embodiment 13: An embodiment of any of Embodiments 1-12 further comprising at least one binder, thickener, defoamer, surfactant, dispersant, matting agent, solvent, antimicrobial agent, pigment, hardener, pH adjuster, or combinations thereof.

Embodiment 14: An embodiment of any of Embodiments 1-13, wherein the primer coating composition comprises: 15%- 50% by weight at least one acrylic latex; 15%- 50% by weight at least one polyurethane dispersion; and 1%- 5% by weight at least one silicate.

Embodiment 15: An embodiment of any of Embodiments 1-14, wherein the primer coating composition is a primer applied over at least one substrate and the substrate is wood, metal, concrete, paper, ceramic, plastic, composites, or combinations thereof.

Embodiment 16: An embodiment of any of Embodiments 1-15, wherein the primer coating composition contains substantially no acrylamides.

Embodiment 17: An embodiment of any of Embodiments 1-16, wherein the primer coating composition has a viscosity change of no more than 10 units according to ASTM D562 after 5 cycles of freeze thaw resistance testing according to ASTM D2243.

Embodiment 18: An embodiment of any of Embodiments 1-17, wherein the primer coating composition has a thickness difference of no more than 5% according to ASTM D6132 after 75 cycles of repeated thermal cycle testing according to ASTM D6944-15.

Embodiment 19: An embodiment of any of Embodiments 1-18, wherein the primer coating composition is substantially transparent.

Embodiment 20: An embodiment of any of Embodiments 1-19 further comprising at least one topcoat at least partially coated onto the primer coating composition.

Embodiment 21: A method of preparing the primer coating composition of any of Embodiments 1-20.

Embodiment 22: An article comprising the primer coating composition of any of Embodiments 1-20.

What has been described above includes examples of the claimed subject matter. All details and any described modifications in connection with the Background and Detailed Description are within the spirit and scope of the claimed subject matter will be readily apparent to those of skill in the art. In addition, it should be understood that aspects of the claimed subject matter and portions of various embodiments and various features recited below and/or in the appended claims may be combined or interchanged either in whole or in part. In the foregoing descriptions of the various embodiments, those embodiments which refer to another embodiment may be appropriately combined with other embodiments as will be appreciated by one of skill in the art. Furthermore, those of ordinary skill in the art will appreciate that the foregoing description is by way of example only, and is not intended to limit the claimed subject matter, realizing that many further combinations and permutations of the claimed subject matter are possible. It is, of course, not possible to describe every conceivable combination of components or methodologies for purposes of describing the claimed subject matter, but one of ordinary skill in the art may recognize. Accordingly, the claimed subject matter is intended to embrace all such alterations, modifications and variations that fall within the spirit and scope of the appended claims. Furthermore, to the extent that the term “includes” is used in either the detailed description or the claims, such term is intended to be inclusive in a manner similar to the term “comprising” as “comprising” is interpreted when employed as a transitional word in a claim.

What is claimed is:

1. A primer coating composition comprising:
at least one resin; and
at least one silicate;
wherein the silicate is less than 5% by weight of the primer coating composition; and
the primer coating composition contains less than 5% pigments.

2. The primer coating composition of claim 1, wherein at least one resin comprises at least one acrylic latex, at least one polyurethane dispersion, at least one epoxy resin, an alkali-soluble resin, or combinations thereof.

3. The primer coating composition of claim 2, wherein at least one acrylic latex comprises methyl methacrylate, methyl acrylate, ethyl methacrylate, isopropyl acrylate, isopropyl methacrylate, n-propyl acrylate, n-propyl methacrylate, n-butyl acrylate, n-butyl methacrylate, isobutyl acrylate, isobutyl methacrylate, t-butyl acrylate, t-butyl methacrylate, n-pentyl acrylate, n-pentyl methacrylate, isopentyl acrylate, isopentyl methacrylate, neopentyl acrylate, neopentyl methacrylate, n-hexyl acrylate, n-hexyl methacrylate, isohexyl acrylate, isohexyl methacrylate, neohexyl acrylate, neohexyl methacrylate, cyclobutyl acrylate, cyclobutyl methacrylate, cyclopentyl acrylate, cyclopentyl methacrylate, cyclohexyl acrylate, and cyclohexyl methacrylate.

4. The primer coating composition of claim 2, wherein the Tg of at least one acrylic latex ranges from 0° C. to 50° C. as measured by Differential Scanning calorimetry (DSC) using ASTM D6604-00.

5. The primer coating composition of claim 2, wherein at least one polyurethane dispersion is formed from at least one isocyanate having an NCO/OH ratio (isocyanate index) of 1:1 to 5:1.

6. The primer coating composition of claim 1, wherein at least one silicate comprises sodium silicate, potassium silicate, magnesium silicate, calcium silicate, lithium silicate, ammonium silicate, orthosilicates, or combinations thereof.

7. The primer coating composition of claim 1, wherein at least one silicate is a modified silicate.

8. The primer coating composition of claim 1, wherein at least one silicate is a solid.

9. The primer coating composition of claim 1, wherein at least one silicate is a liquid.

10. The primer coating composition of claim 1, wherein at least one silicate is added to the primer coating composition during processing.

11. The primer coating composition of claim 1, wherein at least one silicate is post-added to the primer coating composition.

12. The primer coating composition of claim 1, wherein at least one silicate comprises 2% to 5% by weight of the primer coating composition.

13. The primer coating composition of claim 1 further comprising at least one binder, thickener, defoamer, surfactant, dispersant, matting agent, solvent, antimicrobial agent, pigment, hardener, pH adjuster, or combinations thereof.

14. The primer coating composition of claim 1, wherein the primer coating composition comprises:
15%- 50% by weight at least one acrylic latex;
15%- 50% by weight at least one polyurethane dispersion; and
1%- 5% by weight at least one silicate.

15. The primer coating composition of claim 1, wherein the primer coating composition is a primer applied over at least one substrate wherein the substrate is wood, metal, concrete, paper, ceramic, plastic, composites, or combinations thereof.

16. The primer coating composition of claim 1, wherein the primer coating composition contains substantially no acrylamides.

17. The primer coating composition of claim 1, wherein the primer coating composition has a viscosity change of no more than 10 units according to ASTM D562 after 5 cycles of freeze thaw resistance testing according to ASTM D2243.

18. The primer coating composition of claim 1, wherein the primer coating composition has a thickness difference of no more than 5% according to ASTM D6132 after 75 cycles of repeated thermal cycle testing according to ASTM D6944-15.

19. The primer coating composition of claim 1, wherein the primer coating composition is substantially transparent

20. The primer coating composition of claim 1 further comprising at least one topcoat at least partially coated onto the primer coating composition.

21. A method of preparing the primer coating composition of claim 1.

22. An article comprising the primer coating composition of claim 1.
